(19) United States
(12) Patent Application Publication
(10) Pub. No.: US 2002/0110916 A1
(43) Pub. Date: Aug. 15, 2002

(54) Diagnostic system for ozone-splitting catalytic converters and method of operation

(76) Inventors: Maximilian Fleischer, Hoehenkirchen (DE); Hans-Peter Goettler, Regensburg (DE); Anton Grabmaier, Zeitlarn (DE); Hans Meixner, Haar (DE)

Correspondence Address: BAKER & BOTTS, 30 ROCKEFELLER PLAZA, NEW YORK, NY, 10112

(21) Appl. No.: 10/075,912

(22) Filed: Feb. 14, 2002

(30) Foreign Application Priority Data
Feb. 15, 2001 (DE) 101 071 69.8

(51) Int. Cl. G01N 31/10

(52) U.S. Cl. 436/37; 422/80; 436/135

(57) ABSTRACT

Ozone-splitting catalytic converters can be monitored through the use of conductivity sensors for detecting ozone. Since such sensors rapidly attain operational readiness have low source sensitivities to other gases, and an adequate service life, they can be used in practical applications. Different methods of operation are capable of optimizing the ratio between ozone sensitivity and transverse axis sensitivity of the sensors.

Be it known that WE, MAXIMILIAN FLEISCHER, HANS-PETER GOETTLER, ANTON GRABMAIER, and HANS MEIXNER, citizens of Germany, whose post office addresses are Schlossangerweg 12, 85635 Hoehenkirchen, Germany; Leublfingstr. 9a, 93053, Regensburg, Germany; Am Wenzenbach 1, 93197 Zeitlarn, Germany; and Max-Planck-Str 5, 85540 Haar, Germany, respectively, have invented an improvement in:

DIAGNOSTIC SYSTEM FOR OZONE-SPLITTING CATALYTIC CONVERTERS AND METHOD OF OPERATION

of which the following is a

### SPECIFICATION

FIELD OF THE INVENTION

The invention relates to a system for monitoring catalytic elements for the breakdown of ozone, with particular consideration being given to the function or the functional efficiency of a method for the breakdown of ozone at ground level.

### BACKGROUND OF THE INVENTION

For environmental and health reasons the level of pollution originating from motor vehicles having internal combustion engines, or from power generation by means of fixed combustion systems must be significantly reduced. Hitherto, the preferred solution has been to reduce the total quantity of pollutants generated through suitable combustion control. In modem motor vehicle engines this is achieved through suitable engine design in combination with sensor-controlled engine management systems with ignition mapping. In addition, exhaust emission control is usually performed through the use of catalytic converters. Three-way catalytic converters are used for spark ignition engines, and so-called DENOX catalytic converters for the removal of nitrogen from the exhaust gases from diesel engines.

Another approach to reducing the level of pollution is to remove active pollutants from the ambient air. In this case, there is no direct analysis of the exhaust gas flow from a specific system. This approach is especially promising for the removal of ground-level ozone, which through its heavily oxidizing action exercises a considerable effect on the state of human health. Ozone itself is not a directly emitted gas and can therefore not be removed from the exhaust gas flow. Ozone is produced as a result of complex photochemical reaction balances occurring under solar insolation when nitrogen oxides are present in the outdoor air with the UV fraction of the sunlight playing a significant part in these reactions.

Since ozone is extremely reactive, its quantity can be readily reduced, that is to say it can be totally removed by means of a catalytic converter system with a flow of air passing through it. These catalytic converters are extremely stable, since there is no need for the direct action of strong oxidation catalysts, which are extremely susceptible to poisoning, as in the case of platinum, for example. Systems which essentially bring about adsorption of the ozone on a surface exhibit a sufficiently good effect since the ozone instantaneously breaks down into oxygen. Catalytic coatings suitable for this purpose have recently become commercially available.

Monitoring of the functioning of such ozone control systems needs to be checked; hence a suitable sensor system is required. This is particularly necessary where such ozone control systems are used in motor vehicles. The radiator of the motor vehicle is generally coated with the catalyst. The quantity of ozone is removed from the usually very large volumetric flow of air passing through the radiator. The vehicle therefore contains an ambient air purification system. Such catalytically acting systems constitute all so-called emissions-related components. The legislative authorities in an increasing number of countries are making a so-called On-Board Diagnostic (OBD) system mandatory for all emissions-relevant components.

The monitoring of corresponding ozone-control systems is particularly relevant to the consideration of ozone as an environmental pollutant. At the same time, an OBD system of a catalytic process for breaking down ozone is, where possible, to be monitored to see that it is functioning. In this process, ground-level ozone (O₃) is broken down in oxygen (O₂) by means of a catalytic coating.

Uses of gas detection for detecting ozone are known. Conductivity sensors, in particular, are used for ozone detection. A conductivity sensor for the detection of ozone is, in particular, described in the pending German patent application number 199 24 083.3.

Other known systems for the detection of ozone are based on the principle of electrochemical cells, or on the principle of gas-sensitive field effect transistors. Although sensors based on electrochemical cells achieve a very high accuracy in gas detection, they have a relatively short life of 1 to 2 years. Applications in the sphere of motor vehicle engineering normally demand service lives of 10 to 15 years. In the case of gas-sensitive field effect transistors (FET), an ozone-sensitive material is applied in the duct area of the FET, a potential, which activates the FET, being produced on the sensitive material when exposed to ozone. (See, T. Doll, J. Lechner, I. Eisele, K. Schierbaum, W. Göpel, “Ozone Detection in the PPB Range with Workfunction Sensors Operating at Room Temperature”, Sens. Act. B, 34, 506-510, 1996). Sensors of this type, however, have a short life, generally not greater than 1 year.

In addition, ozone sensors are known that are based on semiconductor metal oxides operated at temperatures in the order of 300° C. Examples of these are sensors, the sensitive materials of which are composed of tungsten oxide (WO₃), pure indium oxide (In₂O₃), or tin oxide (SnO₂). The relatively low operating temperatures of these sensors, however, mean that they take a long time to reach operational readiness. Furthermore, excess gas temperature and gas moisture content have a detrimental effect on the functioning of these sensors.

### SUMMARY OF THE INVENTION

The object of the present invention is to provide a diagnostic system to detect the functioning or the functional efficiency of a catalytic element for breaking down ozone, used, for example, in a radiator of a vehicle. The invention is based on the use of specific ozone sensors in the form of semiconductor gas sensor elements which permit ozone monitoring on catalytic elements, rapid attainment of operational readiness together with low transverse axis sensitivity, and an adequate service life of the sensor system. These are important requirements for the use of such a diagnostic system on catalytic elements. By using a plurality of ozone sensors on an ozone-splitting catalytic element, it is possible, subject to certain constraints, to determine the conversion rate afforded by the system. At least two ozone sensors are used, one arranged upstream of the catalytic element, and the other downstream of the catalytic element in relation to the gas volumetric flow. The ozone concentrations in air upstream and downstream of an element with catalytic coating, such as a vehicle radiator, for example, are determined by corresponding operating methods, which use a differential measurement, for example, to analyze the sensor signals. From the derived ratio it is possible to determine the conversion rate of the system, and thereby to arrive at an indication of the functioning of the catalytic element, given a knowledge of the operating parameters of the overall system such as the velocity of the gas flow, the temperature of the coolant in a radiator, or the temperature of the catalytic converter.

Conductivity sensors, especially ones based on gallium oxide, are known for a rapid attainment of operational readiness and low transverse axis sensitivity. Their sensitivity and selectivity can be further enhanced by coating the gas-sensitive gallium oxide layer with a layer of indium oxide. A suitable gallium oxide layer has a layer thickness, for example, in the order of about 0.5 to about 3 μm, preferably about 2 μm. A suitable thickness of an indium oxide layer is in the order of about 50 to about 500 nm, preferably about 300 nm. Conductivity sensors of this type in principle consist of a substrate, to the front side of which measuring electrodes are applied for measuring the resistance in a gas-sensitive layer as a function of the test gas concentration, and to the rear side of which electrical heating is applied. The interdigital structure of the measuring electrodes is composed, for example, of platinum. The sensors are operated at about 500 to about 750° C. The electrical resistance of the sensor is in this case a function of the ozone concentration of the prevailing gas.

### BRIEF DESCRIPTION OF THE DRAWINGS

The invention is described in greater detail below in conjunction with the drawings in which:

FIG. 1 illustrates the basic structure of a semiconductor sensor chip, formed from a substrate, the front side of which, according to FIG. 1A, has an interdigital electrode structure deposited thereon for measuring the electrical conductivity on a superimposed sensor layer (Ga₂O₃/In₂O₃); and according to FIG. 1B has a substrate on the rear side which carries a zigzag heating element of conductive material, such as platinum; a temperature dependence of the heating conductor strip can be used to determine and control the chip temperature;

FIG. 2 illustrates the sensitivity characteristic of two ozone sensors at a chip temperature of 650° C.;

FIG. 3 illustrates a measurement for the detection of transverse axis sensitivities in damp, synthetic air at a sensor temperature of 650° C. four different sensors having been tested; and

FIG. 4 is a diagram of a diagnostic system using two ozone sensors in a gas flow passing over a catalytic element.

### DETAILED DESCRIPTION OF THE INVENTION

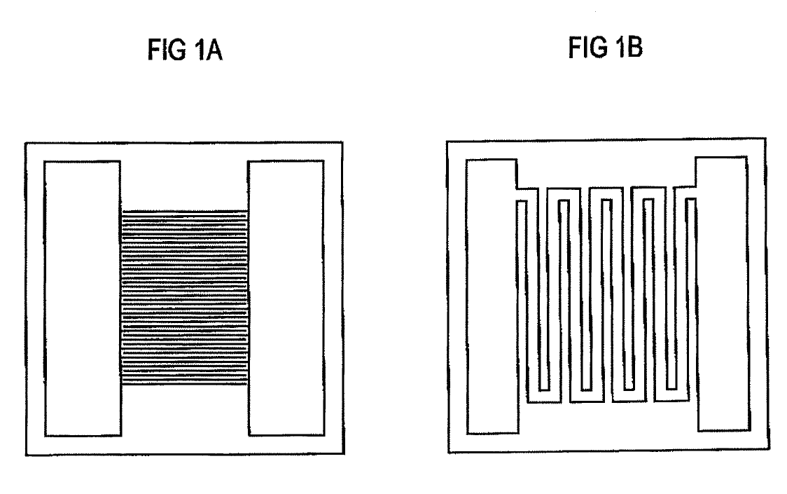

FIGS. 1A and 1B represent essential components of conductivity sensors. These sensors are heated and generally have a heating control for setting a predetermined temperature. Coatings applied to a substrate are generally used as gas-sensitive elements. In particular, metal oxide coatings are used. An interdigital electrode structure according to FIG. 1A is used for measuring the resistance in the sensor coating as a function of the gas concentration.

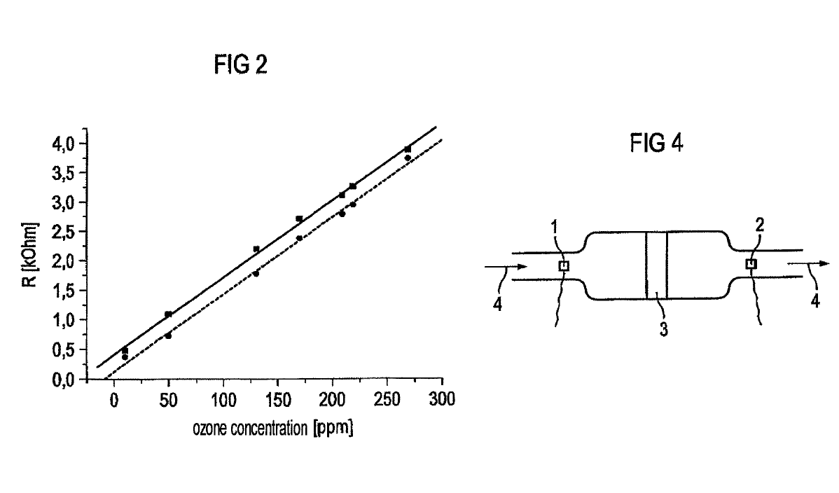

FIG. 2 shows the linear dependence of the sensor resistance on the ozone concentration at an operating temperature of 650° C., measured on two ozone sensors.

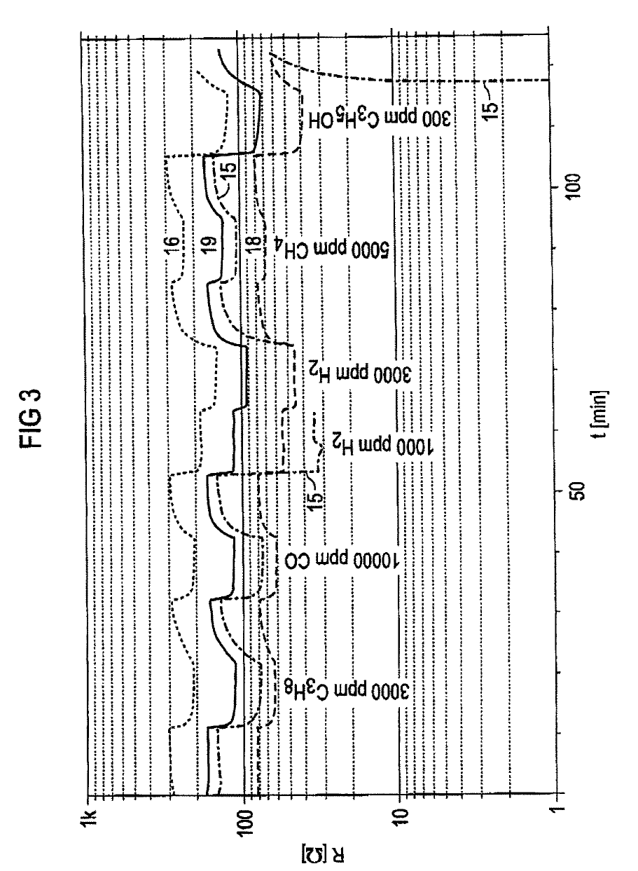

FIG. 3 shows that, with the sensors used, slight source sensitivities to other gases occur, which might adversely affect the ozone measurement. In comparison with the resistance range of several kOhm in the ozone measurement according to FIG. 2, maximum changes of approximately 150 Ohm occur in the case of source sensitivities according to FIG. 3.

FIG. 4 shows a diagram of a catalytic element 3 with a gas flow 4 passing though it. An ozone sensor 1 is connected upstream of the catalytic element and an ozone sensor 2 downstream of the catalytic element 3 in the direction of flow of the gas 4. The ozone conversion rate can therefore be determined by means of a differential measurement.

Control electronics regulate the sensor temperature. Evaluation electronics determine the sensor resistance. The characteristics of the ozone sensors are balanced with one another. The ratio of the ozone concentrations are used as a measure of the efficiency of the ozone breakdown process. If the diagnostic system is used in a motor vehicle, for example, the weighting or relevance of the sensor signals can be determined, taking account of different vehicle conditions, such as vehicle speed, operating time, or temperature.

Since in motor vehicle operation the sensor is exposed to harsh ambient conditions, protective measures must be taken, for example, to counteract splash water and salt spray. This can be solved by using a watertight sensor housing with gas inlet via a gas-permeable membrane. It is possible to use an open, porous, hydrophobic polymer membrane for this purpose, for example one made from water-repellent polytetrafluoroethylene, polyethylene, or polypropylene. This membrane may be supplemented by a further outer membrane of a fiber material arranged on the air side, or even replaced thereby. Optimum shielding from ambient influences can therefore be achieved.

All sensor elements are advantageously accommodated in a common housing and equipped with common electronics. The edited sensor signals may be further processed, for example, by an engine management system. At the same time the driver of a vehicle can also be informed of any possible malfunctions.

The function of the operating method is explained below, first wherein both sensors are operated at a fixed temperature, it being possible to heat both sensors to the same temperature or to different temperatures. The ozone sensor 1 is mounted on the fresh air side in front of a catalytic element, such as a vehicle radiator. Ozone sensor 2 is mounted behind the catalytically active element 3 in the gas flow 4. In an initial evaluation of the signal from the ozone sensor 1, it is assessed whether a conversion measurement is feasible. If so, the ozone sensor 1 indicates whether there is sufficient ozone present. Taking account of vehicle parameters, such as vehicle speed and radiator temperature, for example, it is determined whether it is appropriate to operate the catalytic element, in this case a catalytic converter of a motor vehicle.

In the actual measurement the conversion rate is then determined from the ratio of the signals from ozone sensor 1 and ozone sensor 2. For this purpose, the ozone readings from the two sensors are subtracted one from the other and the difference processed further. In the case of the linear characteristic shown according to FIG. 2, the resistance ratio between the two sensors can easily be evaluated after scaling. This is particularly preferred in the event of any transverse axis sensitivities of the individual sensors. Where these occur in the form of a factorial heterodyning with the ozone signal, the influence of the source sensitivities is eliminated through formation of the resistance ratio between the ozone sensors. In general, low transverse axis sensitivities are to be expected in the use of the sensors described.

Operation of the ozone sensors with a temperature change is explained below. Here the ozone sensor 1 is again arranged on the fresh air side, and ozone sensor 2 is again in the area downstream of the catalytic element. In a first stage it is assessed whether a conversion measurement is feasible. If so, the ozone sensor 1 indicates whether there is sufficient ozone present. Account can be taken of vehicle parameters, such as vehicle speed and radiator temperature. If operation of the catalytic element is appropriate, the ratio of the signals from ozone sensors 1 and 2 is evaluated in a first stage. In a second stage another operating temperature is set for at least one sensor. This has the advantage of modifying the ratio of ozone sensitivity to transverse axis sensitivity. For this second stage, both operating temperatures of the ozone sensors are appropriately adjusted during the measurement. From the resulting four sensor signals from the ozone sensors 1 and 2, each at two temperatures, it is possible to further improve the elimination of the transverse axis sensitivity. The conversion rate can therefore be determined with considerably more accuracy.

We claim:

1. A diagnostic system for ozone-splitting catalytic converters comprising:
a catalytic element in contact with a gas flow,
a plurality of heated conductivity sensors for the detection of ozone, wherein at least a first ozone sensor is arranged in the gas flow upstream of the catalytic element and at least a second ozone sensor is downstream thereof, and
further comprising monitoring means to monitor the functioning of the catalytic element by comparing the ozone concentrations upstream and downstream of said element.

2. The diagnostic system according to claim 1, wherein the ozone sensors have an operating temperature in the range of about 500 to about 750° C.

3. The diagnostic system according to claim 1, wherein the conductivity sensors comprise a gas-sensitive layer of gallium oxide (Ga₂O₃).

4. The diagnostic system according to claim 3, wherein the conductivity sensor comprises a further layer comprising indium oxide (In₂O₃) on at least a portion of the layer of gallium oxide.

5. The diagnostic system according to claim 1, wherein the catalytic element is a motor vehicle radiator.

6. The diagnostic system according to claim 1, wherein the ozone sensors are each arranged in a housing having a gas-permeable inlet membrane.

7. The diagnostic system according to claim 6, wherein the membrane is an open, porous, hydrophobic polymer membrane comprised of a material selected from the group consisting of polytetrafluoroethylene, polyethylene or polypropylene.

8. The diagnostic system according to claim 6, wherein the membrane is comprised of a fiber material.

9. The diagnostic system according to claim 6, wherein a plurality of inlet membranes are connected in series.

10. The diagnostic system according to claim 1, further comprising evaluation electronics, and the sensor elements together with evaluation electronics are in a common housing.

11. The diagnostic system according to claim 1, wherein sensor data is transmitted to an engine management system.

12. A method of operating the diagnostic system in accordance with claim 1, comprising maintaining the ozone sensors at the same operating temperatures during a measurement.

13. A method according to claim 12, wherein a measuring process is divided into two stages, the ozone sensors in a first stage being kept at the same operating temperatures, and at least one operating temperature on at least one of the ozone sensors being adjusted in a second stage.

14. The method according to claim 13, wherein in the second stage of the measuring process the operating temperatures of the two ozone sensors are equal.

15. The method according to claims 12 and 13, wherein prior to a measurement it is determined by evaluation of the signal from a first ozone sensor, whether an adequate ozone concentration and an adequate gas flow are present for an appropriate conversion measurement.

16. The method according to claim 15, wherein the temperature on the catalytic element is taken into account in making the determination.

17. The method according to claim 12, wherein in each measurement a differential signal from the ozone sensors is evaluated.

18. The method according to claim 13, wherein the operating temperature is reduced in order to reduce in the second stage transverse axis sensitivities.

19. The method according to claim 12, wherein the operating temperature of the sensors is in a range between about 500° C. and about 750° C.

20. The method according to claim 12, further comprising balancing the sensors' characteristics with one another.

21. The method according to claim 12, further comprising controlling of operation as claimed in one of the preceding claims, in the heating of the ozone sensors.

22. The method according to claim 19, wherein the operating temperature is about 650° C.

23. The method according to claim 1, comprising maintaining the ozone sensors at different operating temperatures during a measurement.

24. The method according to claim 23, wherein a measuring process is divided into two stages, the ozone sensors in a first stage being kept at different operating temperatures, and at least one operating temperature on at least one ozone sensor being adjusted in a second stage.

25. The method according to claim 24, wherein the operating temperatures of the ozone sensors are equal in the second stage.

26. The method according to claims 23 and 24, wherein prior to a measurement it is determined by evaluation of the signal from a first ozone sensor, whether adequate ozone concentration and an adequate gas flow are present for an appropriate conversion measurement.

27. The method according to claim 26, wherein the temperature of the catalytic element is taken into account in making the determination.

28. The method according to claim 23, wherein in each measurement a differential signal from the ozone sensors is evaluated.

29. The method according to claim 25, wherein the operating temperature is reduced in the second stage in order to reduce transverse axis sensitivities.

30. The method according to claim 23, wherein the operating temperature of the sensor is in a range between about 500° C. and about 750° C.

31. The method according to claim 30, wherein the temperature is about 650°C.

32. The method according to claim 23, further comprising balancing the sensors' characteristics with one another.

33. The method according to claim 23, further comprising controlling the heating of the ozone sensors.
